(19) United States
(12) Patent Application Publication
(10) Pub. No.: US 2007/0091096 A1
(43) Pub. Date: Apr. 26, 2007

(54) DISPLAY DEVICE

(75) Inventors: Han-Che Wang, Shenzhen, Guangdong (CN); Kuan-Hong Hsieh, Shenzhen, Guangdong (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/467,569

(22) Filed: Aug. 28, 2006

(30) Foreign Application Priority Data
Oct. 13, 2005 (CN) 200510100384.5

(51) Int. Cl. G06T 1/00; G06F 15/00

(52) U.S. Cl. 345/501

(57) ABSTRACT

A display device (2) can be coupled to or independent from a host computer (1). When coupled to the host computer, the display device serves as a man-machine interface of the host computer. The display device includes an external operation unit (80), a display unit (20); a memory (60); and a processing unit (50). The external operation unit is provided to produce operational commands corresponding to operational inputs. The processing unit is for receiving data files from the host computer and storing the data files in the memory when the display device is coupled to the host computer, and for reading the data files from the memory and displaying the data files on the displaying unit in accordance with the operational commands when the display device is independent from the host computer.

### 1. TECHNICAL FIELD

The present invention relates to a display device, and particularly relates to a display device which can be attached to and detached from a host computer.

### 2. RELATED ART

Computers are importable tools for people. It is often used to store data files, not only important data files that must be kept hidden from others, but also ordinary data files that need not be kept hidden. For example, ordinary data files such as a daily planner or an ordinary email may be stored in a computer. When reviewing the ordinary data files, it is required to first boot up the computer and wait until the computer has been completely booted up, which is a time consuming process. Furthermore, booting up the entire computer system just to review the ordinary data files is a waste of electrical power.

In regards to portable computer systems, although it has been disclosed that a display unit that is detachable from a mainframes and able to communicate with the mainframes in either a wire or a wireless fashion, thus, achieving a comfortable viewing angle or facilitate users to use the portable computers. However, in such a situation, the display unit is unable to display data files without the mainframe. The entire portable computer system still needs to boot up to view a data file.

Therefore, there is a need for providing a display device that can solve the above-mentioned problem.

### SUMMARY

A display device is provided in accordance with a preferred embodiment. The display device can be coupled to a host computer and serves as a man-machine interface of the host computer. The display device can also be independent from the host computer. The display device includes an external operation unit, a display unit, a memory, and a processing unit. The external operation unit is provided to produce operational commands corresponding to operational inputs. The processing unit is for receiving data files from the host computer and storing the data files in the memory when the display device is coupled to the host computer, and for reading the data files from the memory and displaying the data files on the displaying unit in accordance with the operation commands when the display device is independent from the host computer.

Other advantages and novel features will be drawn from the following detailed description with reference to the attached drawings, in which:

### BRIEF DESCRIPTION OF THE DRAWINGS

FIG. 1 depicts an exemplary block diagram of a display device in accordance with a preferred embodiment of the present invention; and

FIG. 2 depicts a schematic diagram of an external operation unit of the display device in accordance with the preferred embodiment of the present invention;

FIG. 3 depicts another exemplary block diagram of the display device in accordance with the preferred embodiment of the present invention; and

FIG. 4 depicts still another exemplary block diagram of the display device in accordance with the preferred embodiment of the present invention.

### DETAILED DESCRIPTION OF THE EMBODIMENTS

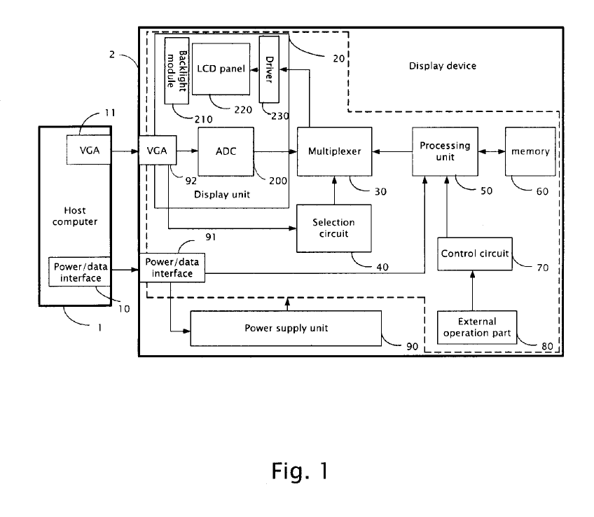

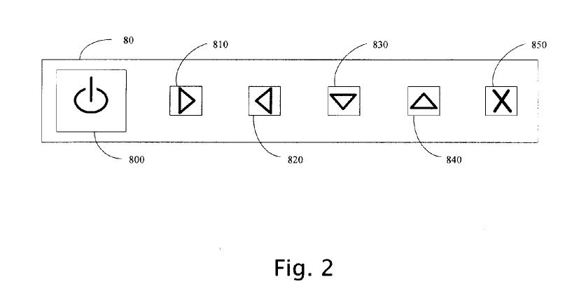

Referring to FIGS. 1 and 2, an exemplary block diagram of a display device and an exemplary schematic diagram of an external operation unit of the display device are shown. As a general overview, in a routine application, the display device 2 provided in accordance with the preferred embodiment is coupled to a host computer 1, and used as a man-machine interface of the host computer 1. However in a particular application, the display device 2 displays information to users independent from the host computer 1.

The display device 2 includes a video interface, such as a VGA (video graphic array) interface 11 employed to couple with a VGA interface 11 of the host computer 1 in the routine application. The host computer 1 transmits video signals to a display unit 20 of the display device 2 via the VGA interfaces 11 and 92. The display unit 20 includes an ADC (analog digital converter) 200, a backlight module 210, an LCD panel 220, and a driver 230. The video signals are first converted by the ADC 200 from an analog form to a digital form and then transmitted to the driver 230 via a multiplexer 30. The driver 230 accordingly drives the LCD panel 220 to display image information of the video signals.

The display device 2 also includes a USB (universal serial bus) interface 91. The USB interface 91 may be coupled with a USB interface 10 of the host computer 1 in the routine application, so that a processing unit 50 of the display device 2 can receive data files from the host computer 1 via the USB interfaces 91 and 10, and store the data files in a memory 60 coupled to the processing unit 50. The host computer 1 provides a user interface (not shown) via the display device 2. The user interface allows users to select a plurality of data files and further transmit (or copy) the data files to the processing unit 50.

When independent from the host computer 1 and in the particular application, the processing unit 50 reads the data files from the memory 60, and transmits the data files to the driver 230 via the multiplexer 30. The driver 230 then drives the LCD panel 220 to display the data files to the users. The multiplexer 30 is controlled by a selection circuit 40. The selection circuit 40 determines if the video signal from the ADC 200 or the data files from the processing unit 50 is transmitted by the multiplexer 30 to the driver 230.

In one way, the selection circuit 40 is coupled with the VGA interface 92. If the VGA interface 92 is in use, the selection circuit 40 controls the multiplexer 30 to transmit the video signals from the ADC 200 to the driver 230. Otherwise, if the VGA interface 92 is idle, the selection circuit 40 controls the multiplexer 30 to transmit the data files from the processing unit 50 to the driver 230. In an alternative way, the selection circuit 40 may be a mechanical switch manually operated by the users. The users switches on or off the selection circuit 40, thus to controls the multiplexer 30 to transmits the video signals or the data files.

The display device 2 further includes an external operation unit 80. The external operation unit 80 receives operational inputs on the display device 2 and produces operational commands upon the operational inputs in the particular application. The external operation unit 80 includes a plurality of buttons, for example, the external operation unit 80 may include a power button 800, data file selection buttons 810 and 820, page up and down buttons 830 and 840, and a data file deleting button 850. These buttons enable the data files stored in the memory 60 to be viewed and managed.

The display device 2 further includes a power supply unit 90. The power supply unit 90 incorporates at least one secondary battery (not shown). When coupled to the host computer 1, the power supply unit 90 receives power from the host computer 1 via the power/data interfaces 10 and 91, charges the secondary battery with the power, as well as powers all power consuming units of the display device 2. When independent from the host computer 1, the power supply unit 90 powers all the power consuming units using the secondary battery. In an alternative embodiment, the power supply unit may receive power from sources other than the host computer 1, for example from an AC/DC (alternating current/direct current) wall adaptor (not shown).

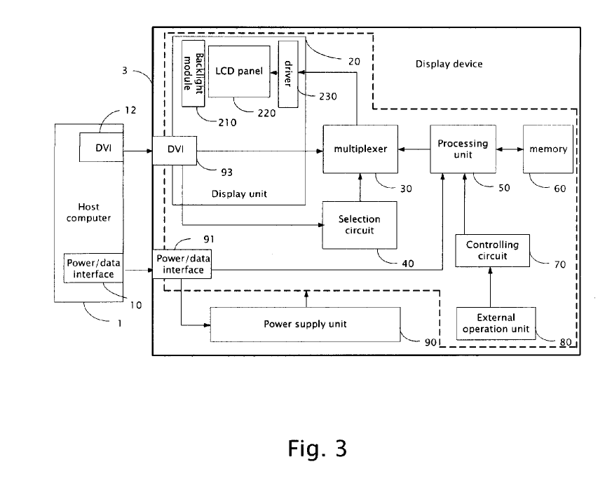

Referring to FIG. 3, another exemplary block diagram of the display device in accordance with the preferred embodiment is shown. In this Figure, the display device 2 includes a DVI (digital video interface) interface 12. The DVI interface 12 may be coupled with a DVI interface 93 of the host computer 1. The host computer 1 transmits video signals to the multiplexer 30 via the DVI interfaces 12 and 93. The selection circuit 40 controls the multiplexer 30 to transmit the video signals to the driver when the DVI interface 93 is in use.

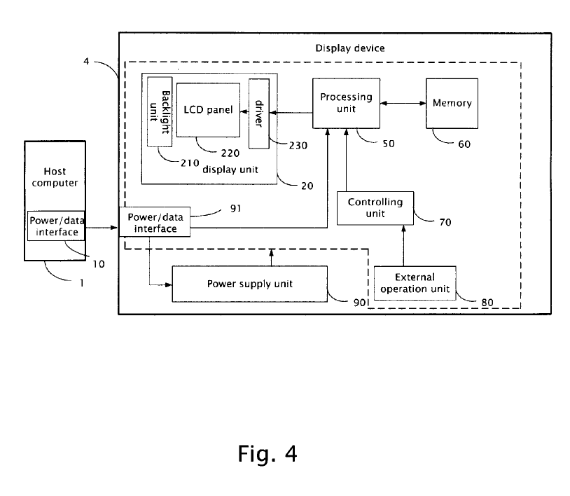

Referring to FIG. 4, a third exemplary block diagram of the preferred embodiment is shown. In this figure, the display device 2 utilizes the power/data interface 91 to receive both video signals and data files from the host computer 1. The video signals and the data files are transmitted to the processing unit 50. The processing unit 50 forwards the video signals to the display unit 20 to display, and stores the data files in the memory 60.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A display device to be coupled to a host computer employed as a man-machine interface of the host computer or to be independent from the host computer, comprising:
an external operation unit for receiving operational inputs and producing operational commands,
a display unit;
a memory; and
a processing unit for receiving data files from the host computer and storing the data files in the memory when the display device is coupled to the host computer, and for reading the data files from the memory and displaying the data files on the displaying unit in accordance with the operational commands corresponding to operational inputs when the display device is independent from the host computer.

2. The display device as claimed in claim 1, further comprising a multiplexer for transmitting video signals from the host computer and the data files from the processing unit to the display unit.

3. The display device as claimed in claim 2, further comprising a selection circuit for signaling the multiplexer to transmit the video signals or the data files to the display unit.

4. The display device as claimed in claim 1, further comprising a control circuit for transmitting the operational commands to the processing unit.

5. The display device as claimed in claim 1, wherein the display device is coupled to the host computer via a video interface and a power/data interface, the video interface receives video signals from the host computer, and the power/data interface receives the data files from the host computer.

6. The display device as claimed in claim 1, wherein the display device is coupled to the host computer via a power/data interface, and the power/data interface receives both video signals and the data files from the host computer.

7. The display device as claimed in claim 6, wherein the processing unit receives the video signals from the power/data interface and transmits the video signals to the display unit.
